(19) United States
(12) Patent Application Publication
(10) Pub. No.: US 2001/0047621 A1
(43) Pub. Date: Dec. 6, 2001

(54) INJECTION SYSTEM AND METHOD FOR ODORIZING NATURAL GAS

(76) Inventor: JOE FRANK ARNOLD, BIRMINGHAM, AL (US)

Correspondence Address: Kenneth C. Hill, Hill & Hunn LLP, 201 Main Street Suite 1440, FORT WORTH, TX, 76102, US

(21) Appl. No.: 09/343,128

(22) Filed: Jun. 29, 1999

(51) Int. Cl. C10J 1/28; F17D 5/02

(52) U.S. Cl. 48/195; 48/127.3; 48/194

(57) ABSTRACT

A system and method for odorizing natural gas in a pipeline uses an odorant injection pump operated by a programmable controller. In response to measured gas flow in the gas pipeline, and a preset setpoint, the injection pump injects liquid odorant directly into the pipeline. A flowmeter in the odorant line measures the amount of odorant actually injected to confirm that the required amount enters the pipeline. If the amount of odorant actually injected differs from that which is required by the setpoint, the controller compensates for the difference. The controller preferably logs pertinent data about operation of the system. The controller can be reprogrammed remotely to simplify the task of changing system operation.

### BACKGROUND OF THE INVENTION

1. Field of the Invention

The present invention relates generally to odorization of natural gas, and more specifically to an improved system and method for injecting liquid odorant into natural gas flowing in a pipeline.

2. Description of the Prior Art

Natural gas is odorless. Because of its potentially dangerous nature, for many years federal regulations have required the addition of an odorant to natural gas so that it can be detected by smell. Odorants such as tertiary butyl mercaptan (TBM) and various blends of commonly accepted chemicals are in common use in the industry.

The odorants added to natural gas, which are provided in liquid form, are often added to the gas at the location where distribution gas is taken from a main gas pipeline and provided to a distribution pipeline. At this point, the gas pressure is stepped down through a regulator, typically from a pressure of approximately 600 psi or more to a lower pressure of approximately 100 psi or less. The odorants can also be added to gas in the main transmission pipeline.

Odorants used with natural gas are extremely concentrated, so that only a small amount of liquid is needed to odorize a relatively large volume of natural gas. For example, with odorants such as TBM and other blends, it is common to use approximately 0.75 lbs. of liquid odorant to adequately odorize 1,000,000 SCF of natural gas.

Odorants such as TBM and other blends are mildly corrosive, and very noxious. It is important that a correctly measured amount of odorant be added to natural gas; otherwise, various problems will result. For example, over-odorization results in excess odors within the valves, pipes, and other equipment used in natural gas distribution. In addition, too much odorant causes the distinctive odorant smell to be noticeable even after the natural gas is burned. This leads to consumer calls complaining of natural gas leaks, each of which must be responded to by the natural gas distribution company. The expense of such calls, when there is no leak involved, is quite high.

It is also important that the odorant levels not be too low. Safety considerations mandate that a natural gas leak be easily detectable by most people. The proper concentration of odorant within natural gas provides this safety measure, but under-odorization is dangerous because actual leaks may not be detected in time.

Two primary techniques are in current use to provide odorization to natural gas in a main distribution pipeline. One technique involves injecting liquid odorant directly into the pipeline. A high pressure injection pump pumps odorant from a liquid storage tank into a small pipe which empties directly into the main gas pipeline. Because the odorant is so volatile, drops injected into the pipeline immediately disperse and spread throughout the gas in the pipeline. Within a few seconds, a few drops of liquid odorant are evenly distributed in gaseous form.

Flow of gas in the pipeline is metered, so that liquid odorant can be injected periodically. Typically, for example, a few drops of odorant is all that is required for a 1,000 SCF of natural gas. When the gas flowmeter indicates that 1,000 SCF of natural gas have flowed through the pipe, the corresponding, pre-calculated amount of liquid odorant is injected into the pipeline. Every time another 1,000 SCF of gas flows past the injection point, another injection is made. Even though the injection is periodic, the odorant quickly becomes a gas and diffusion within the natural gas provides for adequately, and relatively even, odorant levels throughout the pipeline.

The injection technique has several important drawbacks. First, as described above, the liquid is extremely noxious. The pump must be designed so that no odorant can leak out. This requires a pump design which is relatively expensive and complex in order to stand up to operating conditions. Failure of this relatively complex injection pump results in the failure of the odorization system. Often, pump failure results in odorant being released at the odorization site, with little or none entering the gas pipeline.

The second technique for odorizing natural gas involves bypassing a small amount of natural gas, at a slightly higher pressure than the low pressure distribution pipeline, through a tank containing liquid odorant. This bypass gas absorbs relatively high concentrations of the odorant while in the tank. When this heavily odorized bypass gas is placed back into the main pipeline, the odorant, now in gas form, diffuses throughout the pipeline in much the same manner as was the case with the liquid injection system.

Because the bypass gas picks up such large amounts of odorant from the liquid in the tank, becoming completely saturated with odorant gas, it is necessary that carefully monitored small amounts of bypass gas be used. The present approach is to allow a small amount of bypass gas to flow into a holding bottle having a known volume. The bypass line is then closed, and the gas in the bottle is allowed to flow into the odorant tank. This displaces an equivalent amount of saturated bypass gas already in the tank, which then travels into the distribution pipeline.

This bypass technique avoids the failures which can occur with the odorant pumps of the injection technique, but has drawbacks of its own. The valving used to pipe natural gas into the measuring bottle can fail, although this is less likely than failure of an injection pump. However, the bottle is of a fixed size, and cannot easily accommodate large changes in the rate of gas flow through the distribution pipeline. For example, if the bypass bottle was correctly sized for a gas flow of 100,000 SCF per hour, increasing flow in the pipeline to 500,000 SCF per hour can cause difficulties with this technique. Because the size of the bottle cannot change, it must be replaced, or operated five times as often for the higher gas flow. Depending upon the design of the system, this may not be physically possible. For example, if the bottle is operated once every four seconds at the low flow rate, and has a one second cycle time, it is not possible to operate the same equipment at a rate more often than once per second. This situation would necessitate changes to the equipment in the field.

It would be desirable to provide an injection system and method which overcomes the drawbacks of the prior art, and which is flexible in setup and operation. It would be further desirable for such a system to be reliable in operation, and provide capability for adjusting its operation to compensate for partial failures of equipment in the field.

### SUMMARY OF THE INVENTION

Therefore, in accordance with the present invention, a system and method for odorizing natural gas in a pipeline uses an odorant injection pump operated by a programmable controller. In response to measured gas flow in the gas pipeline, and a preset setpoint, the injection pump injects liquid odorant directly into the pipeline. A flowmeter in the odorant line measures the amount of odorant actually injected to confirm that the required amount enters the pipeline. If the amount of odorant actually injected differs from that which is required by the setpoint, the controller compensates for the difference. The controller preferably logs pertinent data about operation of the system. The controller can be reprogrammed remotely to simplify the task of changing system operation.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a diagram of a preferred natural gas odorizer system constructed in accordance with the present invention;

FIG. 2 is schematic diagram of the electronics and controller of the preferred odorizer of FIG. 1;

FIG. 3 is a flowchart illustrating operation of the preferred controller; and

FIG. 4 is a graph illustrating odorant changes in volume as a function of temperature changes.

### DESCRIPTION OF THE PREFERRED EMBODIMENT

As described below, the preferred embodiment of the present invention injects liquid odorant directly into a natural gas pipeline. When a known unit of natural gas flows through the pipeline, a calculated amount of odorant, needed to properly odorize that amount of natural gas, is injected into the pipeline. The amount of odorant is measured as it is pumped into the pipeline to confirm that the correct amount of gas was indeed injected. If the measured amount differs from the calculated amount, the controller determines the amount of the difference and compensates for it. Each cycle of injecting odorant is referred to as an injection pulse.

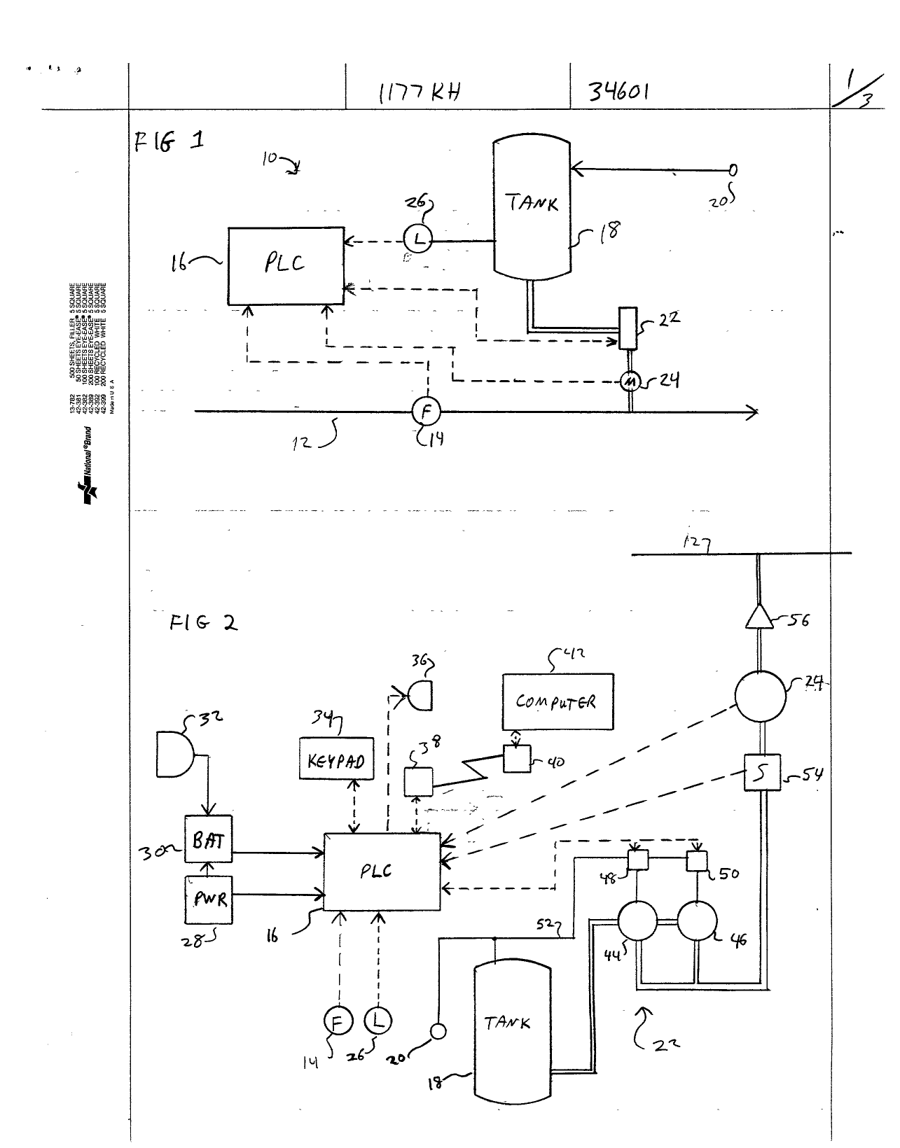

Referring to FIG. 1, a gas odorization system 10 is shown schematically. Natural gas flows through a pipeline 12, and the rate of gas flow is measured by a flowmeter 14. A Programmable Logic Controller 16 (PLC) is connected to the flowmeter 14 to measure the amount of gas flowing through pipeline 12.

A tank 18 of liquid odorant is provided as part of the odorization system. The liquid odorant in the tank 18 is maintained under pressure from a gas pressure source 20. The source 20 can be natural gas or some inert gas such as nitrogen, and is of a pressure high enough to ensure liquid odorant will flow into odorant injection pump 22. This pressure need not be very high, and can preferably be 10-40 psi. It may be provided as a regulated tap from a high pressure gas line, or by a compressor, or a pressurized gas bottle.

Injection pump 22 can be any liquid injection pump widely available in the industry, and can be, for example, a Linc 85-11. Injection pump 22 is connected to the controller 16 through a solenoid, and operates only in response to commands received from the controller 16. When commanded to do so by the controller 16, pump 22 injects liquid odorant directly into pipeline 12 through a meter 24. Meter 24 is a positive displacement or other suitable flowmeter, and sends an electronic signal to the controller 16 indicating the amount of odorant which is actually injected into the pipeline 12.

As will be described below in more detail, inclusion of the flowmeter 24 allows for confirmation that the intended amount of odorant was actually injected, and for a determination of the difference from the intended amount if it was not. In the latter case, compensation can be made by the controller 16 to ensure proper odorization even in the event of a partial failure of the pump 22.

In the preferred embodiment, an optional level meter 26 is provided with the odorant tank 18. This allows for verification, over an extended period, of odorant usage as measured by the flowmeter 24 and for warning about low levels of odorant in the tank 18. The latter allows an operator to receive notification that the tank 18 needs to be refilled. Several models of level sensor 26 are available in the industry, and any meter suitable for use with the controller 16 can be used.

Referring to FIG. 2, the control system for the odorizer is shown in more detail. In addition to the equipment described in FIG. 1, the controller 16 is connected to an appropriate power supply 28. This supply may be connected to available AC sources, or may be provided by alternative sources such as a generator. In case of any failure associated with supply 28, a backup battery 30 is provided. This battery can be kept charged by the supply 28, or can be charged by a solar supply 32 as known in the art. If the situation warrants, main supply 28 can be dispensed with, and power provided entirely by solar supply 32 and battery 30.

Several controls are provided to program and monitor controller 16. These include a keypad/display unit 34 connected directly to the controller 16. Using the keypad 36, an operator can program operation of the controller 16 as described below. The operator may also display data indicating operating conditions of the odorizer 10, including diagnostics of the controller 16 itself, and historical operating data which has been logged during operation of the controller 16.

If operation of the controller 16 departs from intended operating conditions, an alarm 36 is activated. This can included visual and audible alarms at the site, and remote alarms signalled at a central facility. For example, if the injection pump 22 fails, an alarm will generally be sent via direct connection, radio, or dial up telephone connection to an operator at a central facility. This allows the failure to be corrected as soon as possible to ensure that all safety regulations are met regarding odorization of the gas. Provision of such alarms is well known in the art, and any appropriate techniques may be used.

In addition to the keypad, a serial connection is preferably provided for controller 16. The preferred embodiment includes a modem 38 connected to the controller 16. Modem 16 can connect to a remote modem 40 over a telephone link, and through modem 40 to a remote computer 42. Through the link provided by modems 38, 40, the remote computer 42 can reprogram the controller 16 to modify its operation in response to changing conditions. Also, the remote computer 42 can download all available diagnostic and operational data available at the controller 16. This can be used to monitor normal operation, check status of the system after an alarm is generated, or for any other purpose. In addition to connecting via modems, the computer 42 can be directly connected to a standard serial or other communications port. This is especially useful if computer 42 is a laptop computer which can be transported to the site of the odorizer 10.

Pump 22 is implemented using one or two separate pumps 44 and 46, which are actuated by solenoids 48 and 50, respectively. Solenoids 48, 50, when actuated by controller 16, allow pressurized gas from source 20 to flow through line 52 and operate respective pumps 48, 50. Preferably, pumps 48, 50 are any widely available gas operated injection pump, and may be, for example, a 85-11 available from Linc Manufacturing Company.

Two pumps 44, 46 may be provided for redundancy. They may be operated in tandem to inject odorant into the gas line 12. Also, they may be operated alternately, with each pump performing for an injection pulse, then waiting for the other to inject odorant on the next injection pulse. If desired, one pump can be designated as a primary pump, with the other used for backup purposes only. It is a simple matter to designate to the controller 16 which option will be used as is known in the art, and in fact the controller 16 can be reprogrammed to change the injection strategy option as desired. Which approach is selected will depend upon the equipment used to implement the odorizer 10, and the preference of the operator.

Flow sensor 54 is provided for safety and backup. Flow sensor 54 is preferably a simple sensor which registers the flow of liquid through it, without measuring the amount. Such sensors can be constructed very reliably. Flow sensor 54 is provided as a check for flow meter 24. If meter 24 indicates that odorant is flowing into pipeline 16, but sensor 54 does not, an obvious error is occurring in one or the other. An alarm is generated, and an operator can replace the faulty unit. If meter 24 fails, indicating either constant flow or no flow, sensor 54 will indicate the condition by properly indicating odorant flow. In this case, the controller 16 can assume failure of meter 24, and continue operating injection pumps 44 and 46, using the calculated capacity of the pumps, until the meter 24 can be replaced.

In the preferred embodiment, pumps 44, 46 are gas actuated piston pumps which deliver a known quantity of liquid with each stroke. As will be described below, the known delivery per stroke is used when selecting the pumps to be used, based upon desired system operating parameters. Preferably, the liquid delivery of each pump equals the amount of odorant which is to be delivered for each odorant injection pulse. It is also acceptable for the pumps to deliver a known fraction of the odorant to be delivered for each injection, such as one-half, allowing two pump cycles to equal one injection pulse.

Check valve 56 prevents odorant from being forced back into the system by back pressure in the gas pipeline.

To program the controller 16 with the proper operating values, it is necessary to know the required setpoint. The rate of odorant use must be selected to define the setpoint. This is typically a value such as 0.75 pounds per MMSCF of gas, and is selected by the operator in accordance with desired odorization rates.

Next, the volume of gas corresponding to each injection pulse is calculated. Given the odorization rate setpoint, the known density of the liquid odorant, and the amount of odorant injected with each pulse, the unit volume of natural gas which must correspond to a pulse is easily calculated. The amount of odorant injected can be programmed into the controller 16 in advance, or can be measured by the flowmeter 24 when the odorizer 10 is placed into service. Preferably, the injection is sized to require an injection pulse for several hundred SCF of gas, typically 100 to 500 SCF.

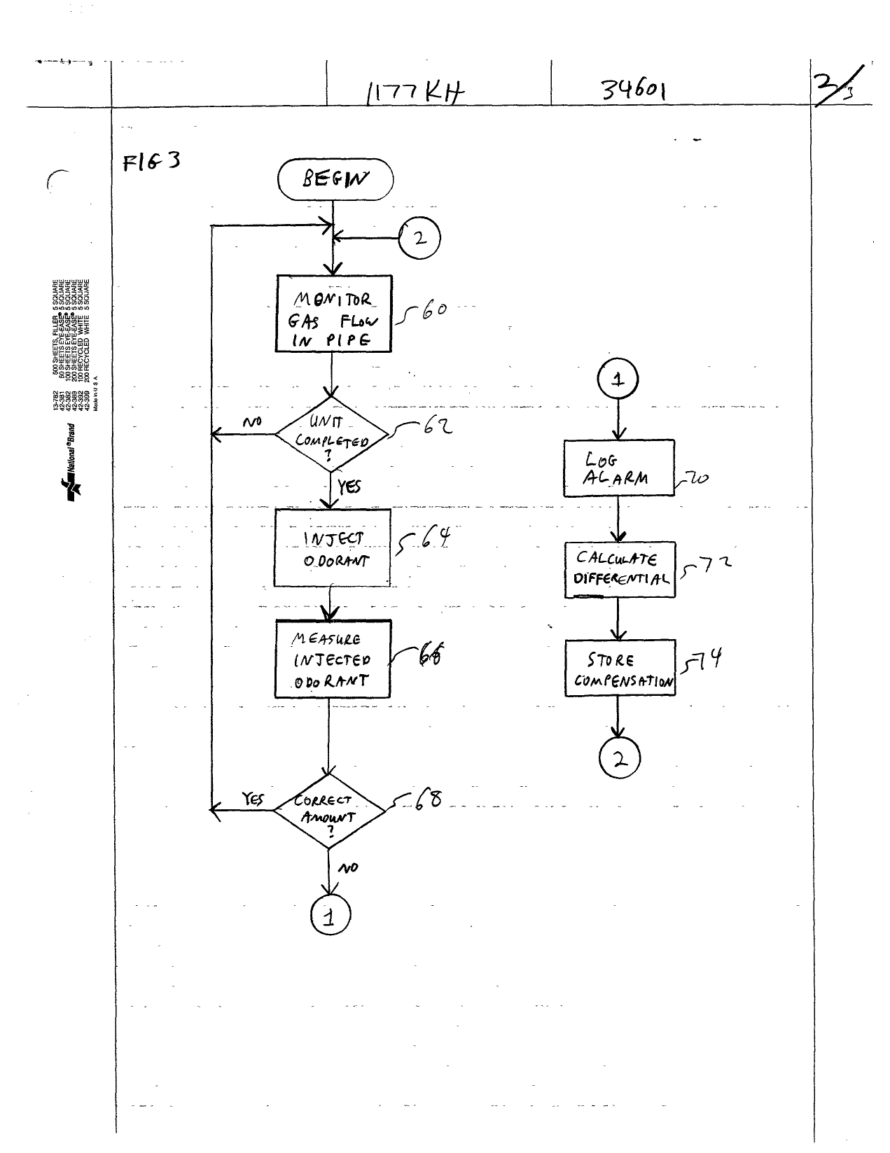

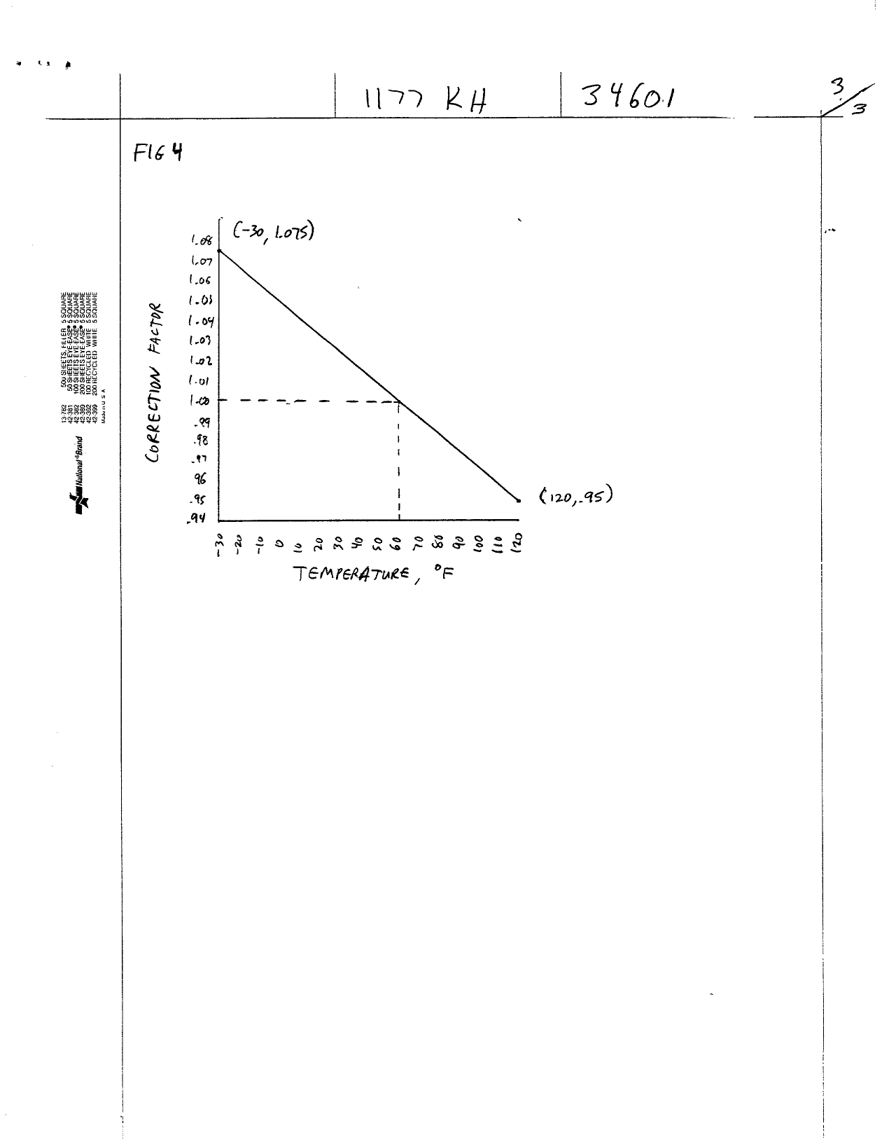

FIG. 3 illustrates the normal operation performed by the controller 16. The controller continuously monitors the flow of gas in the pipeline 60, and checks to see whether a complete unit of gas has flowed through the pipe 62. Each unit corresponds to that volume of gas which must flow to cause a single injection pulse cycle to be performed. If that amount of gas has not yet passed through the pipeline, control returns to monitor step 60.

Once enough gas has flowed through the pipeline, the odorant is injected 64. During the injection step, the amount of odorant actually injected is measured by the odorant flowmeter 66. As described previously, this provides confirmation that the correct amount of odorant is injected for each injection pulse. If this amount is correct, control returns to step 60.

If the amount of odorant injected is not actually the expected amount, the controller 16 must compensate for the difference. There are several methods which may be used, and some may be more suitable than others depending on the details of the installation. In the preferred embodiment, additional pulses are added if the odorant injected is less than it was supposed to have been. The rate of extra injection pulses depends on the difference between the expected volume and the actual volume, i.e. the amount of deviation from the setpoint. For example, if the actual volume is ten percent too low, an extra injection pulse is added for every ten which occur under normal circumstances. In a similar manner, if extra odorant is injected in each pulse, a normally sequenced pulse is skipped to compensate in a similar ratio.

Other approaches can be used, depending on the capability of the equipment. If the volume of the pump stroke can be automatically varied, the controller can change the size of the stroke to compensate for under or over odorization. For example, if a single pump stroke is ten percent low, the settings on the pump can be adjusted upwards by ten percent to compensate. These adjustments can be made continuously, using the measured flow for feedback, until the proper volume of odorant is injected.

With current technology, such a variable pump is probably prohibitively expensive. Another, simpler, approach to compensating for inaccurate pumps is to vary the size of the gas unit which flows to trigger an injection pulse. If the volume of the previous injection was ten percent too low, the next gas unit will be scaled down by ten percent to compensate. Thus, for example, if the unit gas size is 500 SCF, and the previous injection was ten percent too low, the next injection will occur after 90% of the normal unit size, or 450 SCF. To be able to compensate in this manner, it is desirable to use an analog flowmeter on the gas pipeline, which can be easily scaled.

Returning to FIG. 3, if step 68 showed that the incorrect amount of odorant was injected in the previous injection pulse, an indication is added to the alarm log 70. This step can include generating an urgent alarm to an operator to correct the problem. The differential from the desired odorant volume is calculated 72, and the appropriate compensation value is then stored 74. As described above, in the preferred embodiment an extra injection pulse is added, or one subtracted, when the accumulated error differential becomes as large as the volume of a single injection pulse.

The compensation techniques described above are seldom needed, if at all, when two identical injection pumps are used. In such case, the malfunctioning pump is simply shut down and all injection performed by the second pump until the problem is corrected. This approach will suffice in all but the most extremely rare situations; the compensation techniques described above will rarely, if ever, be needed in practice.

As described above, the amount of odorant injected is measured for each injection pulse. The measurement may be performed for either odorant mass or volume. If flowmeter 24 is a mass flowmeter, controller 16 is programmed to accept mass measurement input. These are used directly to compare to the setpoint value which is itself expressed in terms of mass of odorant. If flowmeter 24 measures volume, however, controller 16 must convert the volume to mass for comparison with the setpoint. As will now be described, in this case, a correction must be made for temperature, because the odorant density varies with temperature.

As is known in the industry, the liquid odorants typically used to odorize natural gas have a fairly large rate of expansion with increasing temperature. This expansion, and contraction with cooling, causes the mass of the odorant injected to vary for a fixed injected volume. A compensation can be made for this effective variation in density by measuring the temperature of the odorant stored in the tank 18, and adjusting either the volume injected with each pulse, or the timing between pulses. As will be apparent, warmer odorant expands, becoming less dense, and has the same effect on the injection pulses as a pump which is pumping less than the required volume for each pulse. Cooler odorant is denser, and has the same effect as a pump which injects more than the required odorant for each pulse. Compensation for the temperature of the odorant can be made in exactly the same manner as described above for a malfunctioning pump.

Referring to FIG. 4, a curve shows the typical correction factor which needs to be applied with temperature variations. This curve is normalized to 60 degrees F, meaning that no correction need be applied at this temperature. At higher temperatures, the actual mass of injected odorant which is contained in a measured volume is less by the amount shown in the curve. For example, at 120 degrees F a measured volume of odorant has only 95% as much mass as at 60 degrees F. This means that the mass of injected odorant is five percent too low. This five percent compensation factor must be incorporated into the determination of how often injection pulses must be performed. At 120 degrees F, an extra injection pulse should be performed for every 20 regular pulses performed, using the preferred technique of adding or subtracting pulses.

A similar compensation must be made for odorant temperatures less than 60 degrees F. For example, at −30 degrees F, a measured volume of odorant will contain 7.5% too much mass. Thus, an injection pulse must be deleted for every 100/7.5=13.3 regular pulses.

The controller 16 is preferably programmed to operate even in the event of a failure of flowmeter 14. If the signal from flowmeter 14 fails, controller 16 enters one of two modes as selected in advance by the operator. In a first mode, the pumps 44, 46 are operated to inject odorant into the line at a preselected rate as a function of time. In a second mode, the controller injects odorant at the same rate. with respect to time, as the average such injection rate over a previous time period, preferably an hour or two. For example, if gas flow in the hour prior to flowmeter failure was such that an odorant injection pulse was performed every two minutes, the controller continues injecting every two minutes until the problem is corrected or it is reset. This approach assumes that the recent past is the best indicator for the immediate future, and may or may not be the best strategy in the event of flowmeter failure. As an alternative, injection can cease entirely upon flowmeter failure, but the first two alternatives will generally be preferred.

The described system allows for remote control and monitoring of the odorizer. As previously described, in addition to on site control through the keypad or by a direct link with a laptop computer, the controller 16 may be reprogrammed by the remote computer 42 through the communications link. In addition, operational data stored within the controller 16 may be read remotely by the computer 42. This allows for central monitoring and control of a large number of odorizers located in widely separated locations. Normal operating data as well as alarm data can be gathered remotely, so that actual presence at the odorizer site can be minimized.

Further, if desired the controller 16 need not even be located at the site where odorant is injected into the gas line. Instead, the various valves and sensors can be connected to actuators which are remotely controlled, either over a physical connection such as a direct communications line, or by remote radio control. Such an arrangement could be useful for example, when it is desired to control a large number of odorizers from a central location. Instead of using separate controllers at each location, a larger, central computer can be programmed to monitor all of the odorizers simultaneously and control each of them in the same manner as described above. While adding communications burdens to the system, this allows for simpler central control and programming.

While the invention has been particularly shown and described with reference to a preferred embodiment, it will be understood by those skilled in the art that various changes in form and detail may be made therein without departing from the spirit and scope of the invention.

What is claimed is:

1. A system for odorizing natural gas flowing through a main line, comprising:
a first meter on the main gas line which monitors gas flow through the main gas line;
an odorant tank containing liquid odorant;
an injection pump connected to the odorant tank, wherein odorant is pumped by the pump from the tank to the main gas line;
a second meter for measuring flow of liquid odorant into the main gas line; and
a controller connected to the first and second meters and the injection pump, wherein the controller controls operation of the injection pump, and wherein the controller compares the amount of odorant measured by the second meter to a calculated amount, and compensates for differences between them.

2. The system of claim 1, further comprising:
a temperature sensor in the odorant tank, wherein the temperature sensor is connected to the controller and provides a signal thereto proportional to the temperature of liquid odorant in the tank;
wherein the controller compensates for changes in odorant temperature by modifying its control of the injection pump.

3. The system of claim 2, wherein the controller adds additional odorant to the main gas line when the temperature of the odorant is higher than a normalized value, and injects less odorant into the main gas line when the temperature is lower than the normalized value.

4. The system of claim 1, wherein the controller includes an input/output connection, wherein data accepted over the input/output connection can reprogram settings in the controller, and wherein data generated by the controller can be output over the input/output connection.

5. The system of claim 4, wherein the input/output connection is a serial data connection.

6. The system of claim 4, wherein the input/output connection is connected to a modem.

7. The system of claim 4, wherein the input/output connection is connected to a touchpad and an associated display.

8. The system of claim 4, wherein the data generated by the controller includes operating reports.

9. The system of claim 4, wherein the data generated by the controller includes diagnostic information.

10. The system of claim 1, further comprising:
a level sensor in the odorant tank and connected to the controller, wherein the level sensor provides to the controller a signal proportional to the liquid odorant level in the odorant tank.

11. The system of claim 1, further comprising:
a power supply connected to the controller and providing power thereto.

12. The system of claim 11, further comprising:
a backup battery connected to the power supply for supplying power to the controller in case of power supply failure.

13. The system of claim 12, further comprising:
a solar device connected to the battery for providing power thereto.

14. method for odorizing natural gas in a pipeline, comprising the steps of:
providing liquid odorant in a tank;
measuring gas flow through the pipeline;
for each preselected quantity of gas flowing through the pipeline, operating a pump to inject liquid odorant into the pipeline;
each time odorant is injected into the pipeline, measuring the amount of odorant injected; and
if the injected volume differs from a calculated volume, compensating for the difference.

15. The method of claim 14, wherein the step of measuring the amount of odorant injected comprises measuring the volume of odorant injected.

16. The method of claim 15, further comprising the steps of:
sensing the temperature of the liquid odorant in the tank; and
in response to changes in the liquid odorant temperature, modifying operation of the pump to compensate for such changes.

17. The method of claim 14, wherein the step of measuring the mass of odorant injected comprises measuring the volume of odorant injected.

18. The method of claim 14, wherein gas flowing through the pipeline is measured with a flowmeter, and further comprising the steps of:
monitoring operation of the flowmeter;
if the flowmeter ceases operating to accurately measure the flow of gas through the pipeline, opening the valve at regular intervals regardless of the measured gas flow through the pipeline.

19. The method of claim 18, wherein the regular intervals are prestored time intervals.

20. The method of claim 18, wherein the regular intervals are selected to be approximately equal to time intervals in which the valve was opened while the flowmeter was working.

21. The method of claim 14, further comprising the step of:
communicating with a remote computer over a data link, wherein the remote computer is provided with data indicative of operation of the pump.

22. The method of claim 18, further comprising the step of:
accepting data from the remote computer to change the preselected quantity of gas and the calculated odorant volume.

23. The method of claim 18, further comprising the step of:
exchanging diagnostic information with the remote computer over the data link.
